(19) United States
(12) Patent Application Publication
(10) Pub. No.: US 2024/0178616 A1
(43) Pub. Date: May 30, 2024

(54) MULTI-PORT CONNECTOR

(71) Applicant: Hubbell Incorporated, Shelton, CT (US)

(72) Inventor: Connor David Burke, San Antonio, TX (US)

(21) Appl. No.: 18/504,474

(22) Filed: Nov. 8, 2023

Related U.S. Application Data
(60) Provisional application No. 63/384,996, filed on Nov. 25, 2022.

(51) Int. Cl. H01R 13/629; H01R 4/02; H01R 13/41

(52) U.S. Cl. CPC H01R 13/629; H01R 4/023; H01R 13/41

(57) ABSTRACT

A multi-port connector includes a housing with a proximal portion defining outer surfaces of a male-type multi-port connection configured to fit within a female-type multi-port connection. The multi-port connector further comprises pin conductors for electrically connecting to the female-type connection, a prong configured to lock with the female-type connection, and a button configured, when pressed, to displace the prong for unlocking. The button is located on a longer side of the housing. A multi-port connector also includes a mount at the distal end of each pin conductor, and cable seatings with a through opening along a longitudinal direction thereof. Each cable seating is configured to be inserted within the mount of a corresponding pin conductor by an insertion depth. A proximal first end portion of each cable seating is longer than the insertion depth in the longitudinal direction, and a distal second end portion of each cable seating includes metal.

### RELATED APPLICATION(S)

This application claims priority to U.S. Provisional Application Ser. No. 63/384,996, filed Nov. 25, 2023, the disclosure of which is incorporated herein by reference in its entirety and to which priority is claimed.

### FIELD

The present disclosure relates to a multi-port connector, more particularly for connection to a connector of a Wi-Fi access point.

### BACKGROUND

Certain governmental low power indoor (LPI) regulations require that access points for Wi-Fi 6E (802.11ax) applications have integrated antennas. One access point seeking to meet such requirements is the Mist AP45 Access Point (manufactured by Juniper Networks®), which allows for connection with an external antenna that is integrated to the access point in a secured and tamper-proof manner. Access points with external antennas or connectors for Wi-Fi 6E (802.11ax) applications aim to provide various benefits, such as improved signal propagation, e.g., for various deployments, from large public venues (LPVs) to warehouses.

FIGS. 1A, 1B and 1C show an example of an access point 1 with two female-type connectors: a 4-port female-type connector 10, typically configured for 2G/5G applications, and a 6-port female-type connector 20, typically configured for 6G applications. FIG. 1B shows an enlarged portion of the access point 1, with a 6-port male-type connector 30 connected to the 6-port female-type connector 20. FIG. 1C shows the same portion of the access point 1, with a cover 40 over the 6-port male-type connector 30. The cover 40 is fixed to the access point 1 using screws 42, and the screws 42 are covered by stickers 44, thus providing a tamper-proof device with an integrated antenna.

FIGS. 2A, 2B and 2C show the 6-port male-type connector 30 of FIGS. 1B and 1C. This connector 30 suffers from various disadvantages, as next explained.

Among other features, the conventional 6-port male-type connector 30 includes side buttons 32 configured to actuate release prongs that secure the connector 30 to the female-type connector 20. The buttons 32 are difficult to actuate due to their location at opposite shorter sides of the connector 30, which are obstructed by other elements of the access point 1 during installation. It is therefore difficult to disconnect the connector 30 from the female-type connector 20.

Furthermore, during installation, and more particularly when connecting a coaxial cable 50 to a contact pin assembly 34, the conductor 52 of the coaxial cable 50 is typically soldered directly at the grounding plane GP. The space needed for soldering at that location is limited, and for this reason, smaller gauge, high loss cables are used to allow for adequate soldering. This in turns leads to various disadvantages, such as extremely high loss of signal, the need for extremely short cable runs, a larger antenna to offset gain loss through the cable, or an undesirable voltage standing wave ratio leading to irregular signals.

### SUMMARY

In various exemplary embodiments, a multi-port connector includes a housing having a male-type multi-port connection configured to fit within a female-type multi-port connection. A plurality of pin conductors are located at least partially within the housing and configured to electrically connect to the female-type multi-port connection. A plurality of cables extend into the housing and are connected to the pin conductors. The cables are low loss cables.

In various exemplary embodiments, a multi-port connector includes a housing having a male-type multi-port connection configured to fit within a female-type multi-port connection. A pin conductor is located at least partially within the housing and configured to electrically connect to the female-type multi-port connection. A mount is positioned at least partially in the housing and connected to the pin conductor. A cable seating is positioned at least partially in the housing and connected to the mount. A cable extends into the housing, the cable extending through the cable seating and connected to the pin conductor.

In various exemplary embodiments, a multi-port connector includes a housing having a male-type multi-port connection configured to fit within a female-type multi-port connection. A plurality of pin conductors are located at least partially within the housing and configured to electrically connect to the female-type multi-port connection. A plurality of mounts are positioned at least partially in the housing, each of the plurality of mounts connected to a respective pin conductor. A plurality of cable seatings are positioned at least partially in the housing, each of the plurality of cable seatings connected to a respective mount. A plurality of cables extend into the housing, each of the cables extending through a respective cable seating and connected to a respective pin conductor. Each of the cables are joined to the respective cable seating.

In various exemplary embodiments a method of assembling a multi-port connection includes extending a conductive portion of a low-loss cable through a cable seating. The conductive portion is joined to a distal portion of the cable seating. A proximal portion of the cable seating is positioned in a mount of a pin connector. The cable seating and the pin connector are positioned in a port of a housing, the housing having a plurality of ports for receiving respective cables.

In various exemplary embodiments, a multi-port connector includes a housing having a male-type multi-port connection configured to fit within a female-type multi-port connection. A plurality of pin conductors are located at least partially within the housing and configured to electrically connect to the female-type multi-port connection. A latch extends in a proximal direction and configured to lock with the female-type multi-port connection when the male-type multi-port connection fits within the female-type multi-port connection. A button configured, when pressed, to displace the latch for unlocking from the female-type multi-port connection when the male-type multi-port connection fits within a female-type multi-port connection. The button is positioned on the top portion of the housing.

In various exemplary embodiments, a multi-port connector includes a housing, a proximal portion of which defines outer surfaces of a male-type multi-port connection configured to fit within a female-type multi-port connection. The housing has two opposite shorter sides and two opposite longer sides. The multi-port connector further comprises a plurality of pin conductors located at least partially within the housing and configured to electrically connect to a female-type multi-port connection when the male-type multi-port connection fits within a female-type multi-port connection. The multi-port connector further comprises at least one prong extending in a proximal direction and configured to lock with a female-type multi-port connection when the male-type multi-port connection fits within a female-type multi-port connection. The multi-port connector further comprises at least one button configured, when pressed, to displace a corresponding one of the at least one prong for unlocking from a female-type multi-port connection when the male-type multi-port connection fits within a female-type multi-port connection. The at least one button is located on one of the longer sides of the housing.

In various exemplary embodiments, a multi-port connector includes a housing, and a plurality of pin conductors located at least partially within the housing. Each of the plurality of pin conductors has a proximal end configured to face another connector that connects to the multi-port connector and a distal end configured to face away from the other connector. The multi-port connector further comprises a mount at the distal end of each of the plurality of pin conductors, and a plurality of cable seatings with a through opening along a longitudinal direction thereof. Each of the plurality of cable seatings is configured to be inserted within the mount of a corresponding one of the plurality of pin conductors by an insertion depth. A proximal first end portion of each of the plurality of cable seatings is longer than the insertion depth in the longitudinal direction, and a distal second end portion of each of the plurality of cable seatings includes metal.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred embodiments and reference to the accompany drawing.

FIGS. 1A, 1B and 1C show a conventional access point.

FIGS. 2A and 2B shows a conventional 6-port male-type connector.

FIG. 2C shows the conventional 6-port male-type connector of FIG. 2A with part of its housing removed.

FIG. 3 shows a rear perspective view of a multi-port connector according to an exemplary embodiment of the disclosure.

FIG. 4 shows a front perspective view of the multi-port connector of FIG. 3.

FIG. 5 shows a front perspective schematic view of the multi-port connector of FIG. 4 with a top portion of the housing removed.

FIG. 6 shows another perspective schematic view of the multi-port connector of FIG. 3.

FIG. 7 shows a perspective view of a latch of the multi-port connector of FIG. 3.

FIG. 8 shows a top view the pin conductors, cable seatings, and latches of the multi-port connector connected to corresponding coaxial cables.

FIG. 9 shows a perspective, sectional view of a portion of the housing and the button of the multi-port connector.

FIG. 10 shows a perspective view of a portion of the housing, the latch and the conductors.

FIG. 11 shows a rear perspective view of the pin conductors, mounts, cable seatings, and coaxial cables.

FIG. 12 is a front perspective view of FIG. 11.

FIG. 13 is a rear perspective view of a cable seating.

FIG. 14 is a front perspective view of FIG. 13.

FIG. 15 is a perspective view of a pin conductor, mount, cable seating, and coaxial cable showing exemplary joining connections.

FIG. 16 shows a perspective view of an access point with the multi-port connector of FIG. 3 integrated therewith.

FIG. 17 shows a perspective view of another multi-port connector according to an exemplary embodiment of the disclosure.

### DETAILED DESCRIPTION

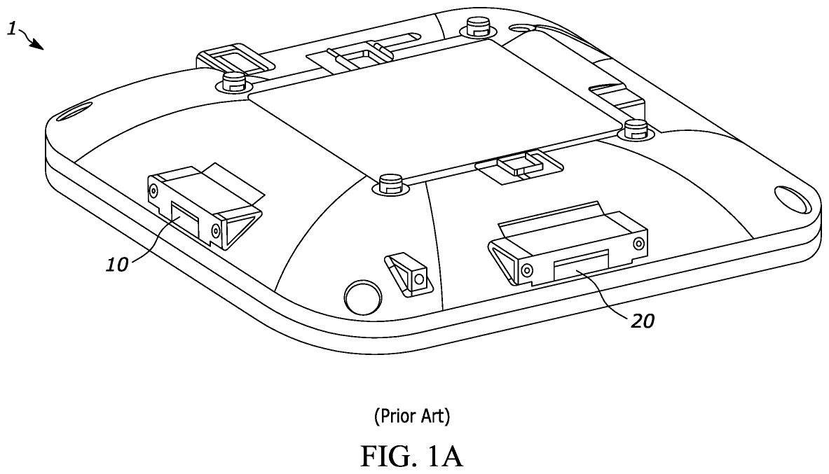

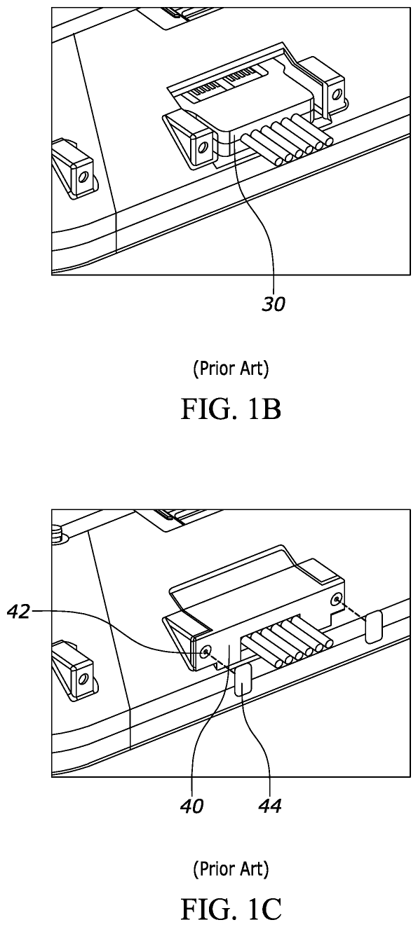

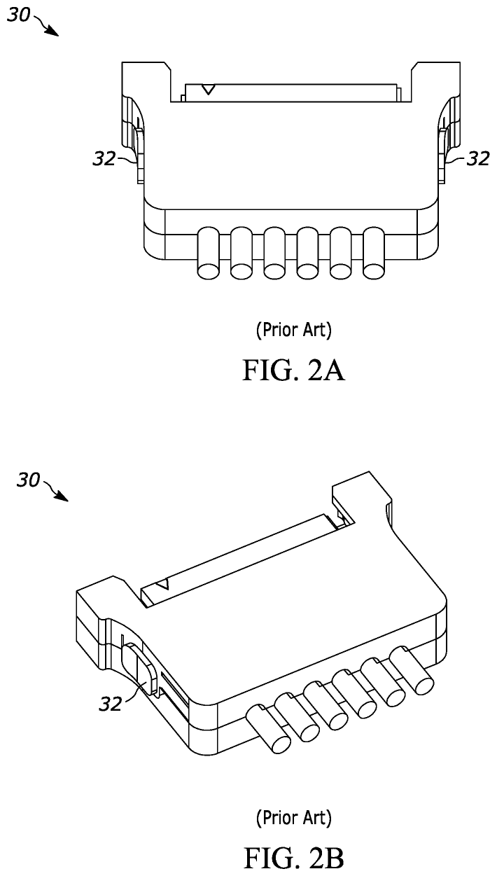

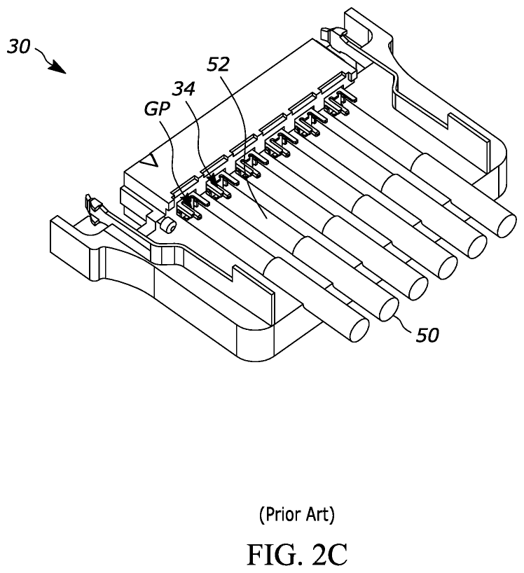

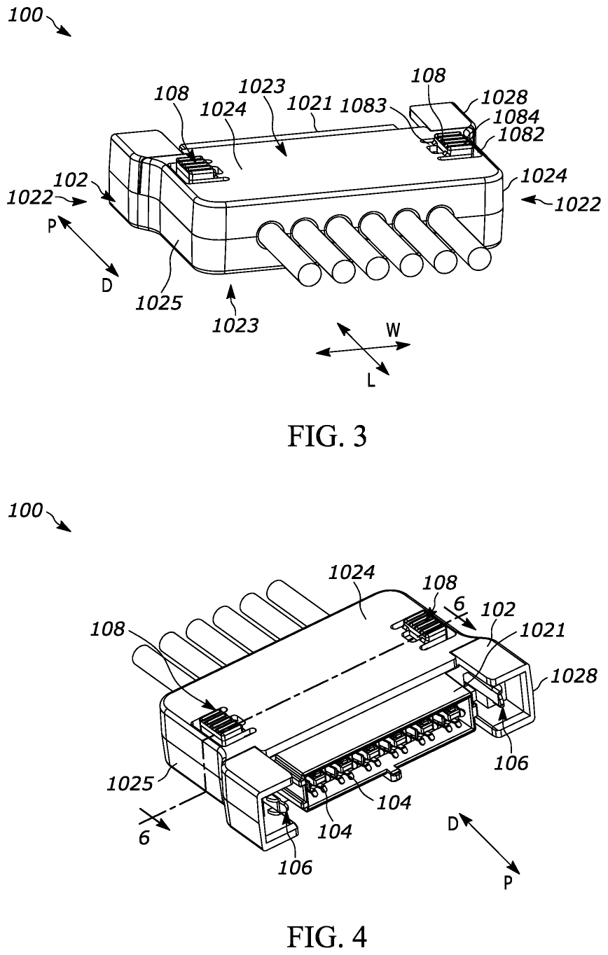

Various exemplary embodiments are directed to a multi-port connector 100 as shown in FIGS. 3 and 4. The multi-port connector 100 includes a housing 102. A proximal portion of the housing 102 includes a flange 1021 which defines outer surfaces of a male-type multi-port connection configured to fit within a female-type multi-port connection (e.g., the female-type connector 20 of FIG. 1A). In the present disclosure, a proximal direction P of the multi-port connector 100 is a direction in which the multi-port connector 100 would be displaced for connecting to another connector, while a distal direction D is a direction in which the multi-port connector 100 would be displaced for disconnecting from another connector. As illustrated, the proximal and distal directions P, D are longitudinal directions L of the multi-port connector 100 and are transverse to a width direction W of the multi-port connector 100.

The housing 102 can include any number or combination of rectilinear or curvilinear sides or outer faces. In certain configurations, the housing 102 has two opposite shorter sides or minor outer surfaces 1022 and two opposite longer sides or major outer surfaces 1023, having a substantially rectangular configuration. The housing 102 may be formed of multiple parts. For example, a top portion 1024 of the housing 102 may be attached to a bottom portion 1025 of the housing 102, e.g., using screws 1026 and/or any other suitable housing attachment mechanism, such as, but not limited to, a snap fit attachment, adhesive, welding, etc. The configuration (i.e., size, shape, number of sides, etc.) of the housing can vary as needed based on the application, the associated connector, or related device.

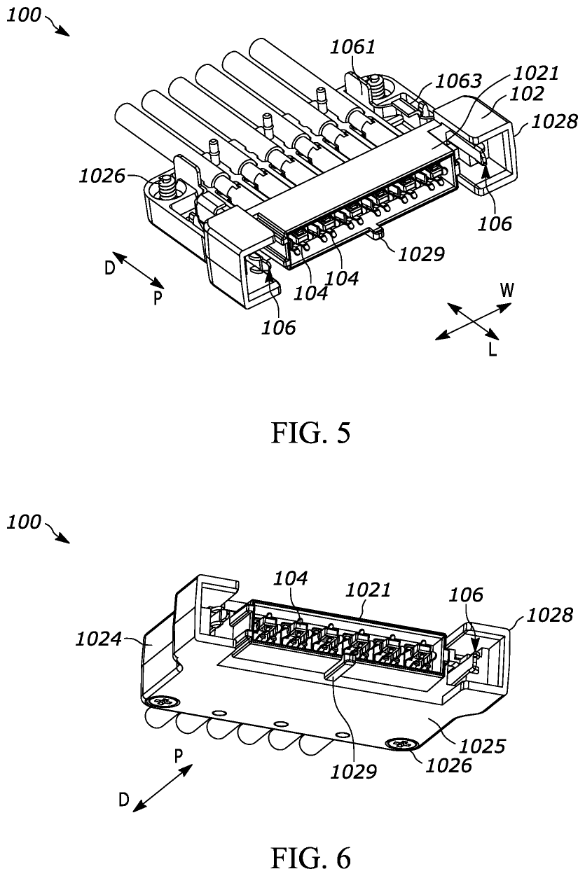

In some embodiments, the multi-port connector 100 includes a plurality of pin conductors 104 as shown in FIGS. 4-6. The pin conductors 104 can be located at least partially within the housing 102, for example at least partially surrounded by the flange 1021. The pin conductors 104 are configured to electrically connect to a female-type multi-port connection when the male-type multi-port connection 100 fits within a female-type multi-port connection. The plurality of pin conductors 104 can be collinearly arranged along the width direction W of the multi-port connector 100, parallel to a main plane of a longer side 1023. A protrusion 1029 can extend from the flange 1021 to help provide alignment with a corresponding connector. For example a female connector can include an opening which receives the protrusion 1029.

In some embodiments, the multi-port connector 100 includes one or more latches 106 which extend in the proximal direction P and are configured to lock with a female-type multi-port connection when the male-type multi-port connection fits within a female-type multi-port connection.

As shown in FIGS. 4-6, the latches 106 can be positioned inside of sleeves 1028. The sleeves 1028 can be extensions of the sides 1022, and in certain configurations can extend outwardly from a main body of the housing 102 so that the sleeves 1028 have a greater width. The sleeves 1028 can be adjacent the ends of the flange 1021 of the housing 102 that contains the pin conductors 104. The sleeves 1028 can have a substantially U-shaped configuration with outer walls that are spaced from the latches 106, providing room for movement, such as flexure, of the latches 106 as needed for connection.

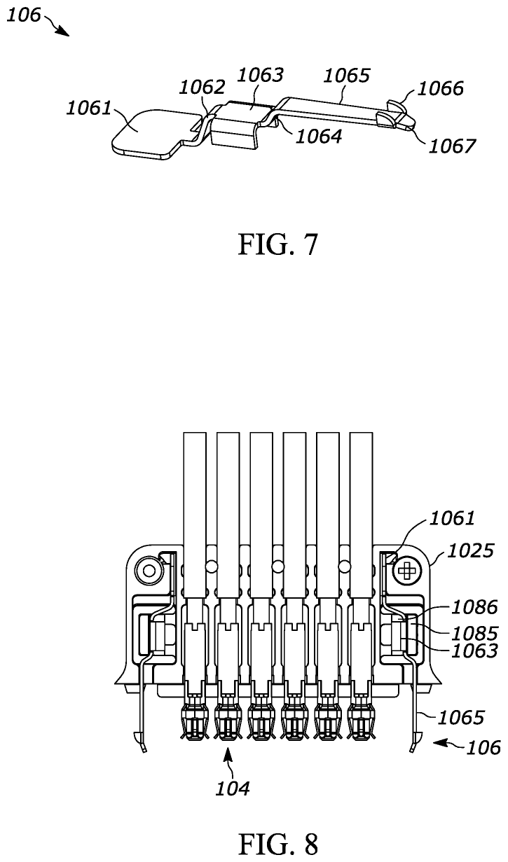

In certain configurations the latches 106 can include a base 1061, a first leg 1062, a deflection member 1063, a second leg 1064, and a prong 1065, as best shown in FIG. 7. The base 1061 can have a substantially flat, rectangular configuration with rounded corners. The first leg 1062 extends between the base and the deflection member 1063. The first leg 1062 can have an S-configuration to space the deflection member 1063 in two directions from the base 1061, for example in both the longitudinal and width directions. The deflection member 1063 has a substantially U-shaped configuration with a main body and a pair of arms extending from the main body. The second leg 1064 extends between the deflection member 1063 and the prong 1065. The second leg 1064 can have an S-configuration to space the prong from the deflection member 1063 in the longitudinal and width directions. The prong 1065 has an elongated body extending form the second leg 1064. The proximal portion of the prong 1065 can include a pair of tabs 1066 extending from either side of the prong 1065. The prong 1065 can include an end section 1067 that extends at an oblique angle to the remainder of the prong 1065. In some embodiments, the one or more tabs 1066 on the latches are configured to abut with a corresponding locking surface of a female-type multi-port connection for locking the male-type multi-port connection 100 to a female-type multi-port connection.

As shown in FIG. 8, the latches 106 can be received in the housing 102 so that the base 1061 is substantially fixed in place. The deflection member 1063 and the prong 1065 can be spaced from one or more interior walls of the housing 102 in a neutral or an unstressed configuration.

In some embodiments, the multi-port connector 100 includes at least one button 108. As shown in FIGS. 3 and 4, a button 108 can be positioned on both sides of the housing 102 and extending from the top portion 1024. In other configurations, the buttons 108 can extend from the lower portion 1025. The button 108 can be separated from the top portion 1024 on one or more sides by a slot 1082. For example the slot 1082 can surround three sides of the button 108. One or more flexures 1083 can bridge the button 108 to the top portion 1024. These flexures 1083 can be configured to movably connect the button 108 to the top portion 1024 so that the button can be pushed inward relative to the housing 102 by a user. The button 108 can therefore be configured to move in a first direction that is different from a second direction of movement of the latches 106. In certain configurations, the button 108 moves in a direction substantially orthogonal to the movement direction of the latch 106.

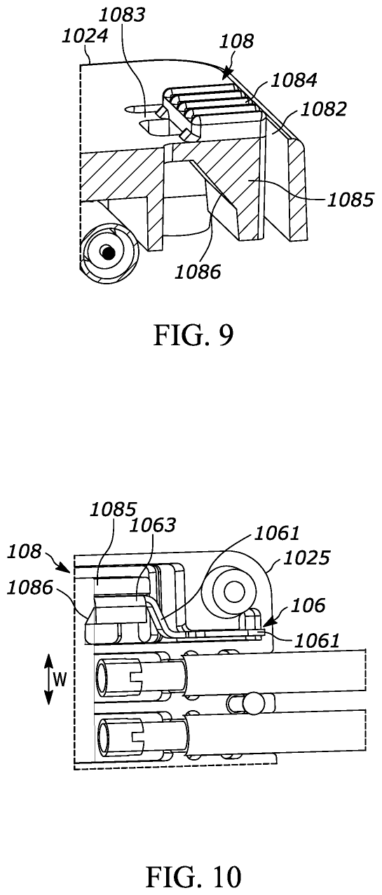

As best shown in FIG. 9, the button can include an upper portion have a series of ribs 1084 and a lower portion having a leg 1085 that extends into the housing 102. The leg 1085 can have an engagement surface 1086 that extends at an angle toward a free lower end of the leg 1085. The engagement surface 1086 is configured to engage the deflection member 1063 of the latch 106. The button 108 therefore can be configured, when pressed, to displace a corresponding one of the latches 106 to unlock the multi-port connector 100 from an associated female-type multi-port connection.

In the illustrated embodiment, the latches 106 are caused to at least partially pivot toward each other, namely, toward a central axis of the multi-port connector 100. For example, the prong 1065 is made to pivot relative to the base portion 1061 of the latch 106 which is located within a groove of the housing 102. A shown in FIG. 10, the deflection member 1063 of the latch 106 can urged by the button 108 engagement surface 1086 to displace the prong 1065 in a width direction W of the multi-port connector 100, thus temporarily bending the prong 1065. The arms of the deflection member 1063 can engage an interior wall of the housing 102 to limit the movement to prevent damage to the latch 106.

In the illustrated embodiments, the one or more buttons 108 are located on an outer surface of the top portion 1024 of the housing 102. As a result, it is easier to actuate the one or more buttons 108 to release the one or more latches 106 when the multi-port connector 100 is connected to a female-type connector, such as, for example, the female-type connector 20 of FIG. 1A. This is because the one or more buttons 108 are located on a side of the multi-port connector 100 that is unobstructed by other elements of the access point 1 after installation. It is therefore much easier to disconnect the multi-port connector 100 from a female-type connector, such as, for example, the female-type connector 20 of FIG. 1A. In other configurations, the buttons 108 can be located on different portions of the housing to achieve the same result, dependent on the application and the configuration of the associated connector.

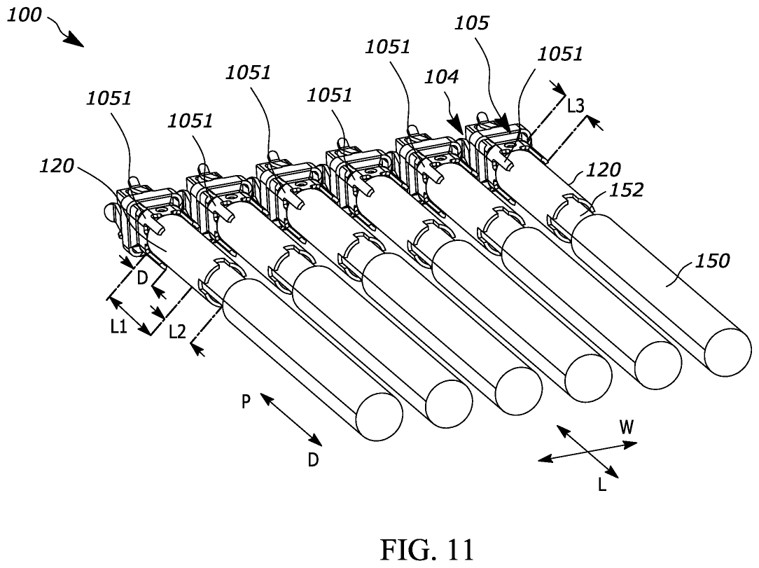

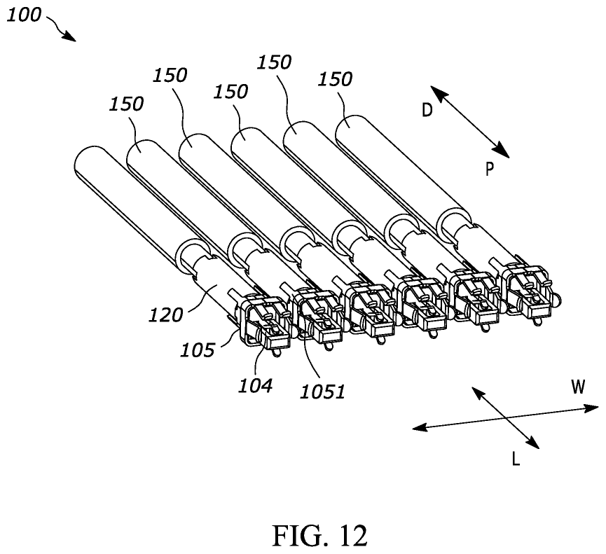

As illustrated in FIGS. 11 and 12, in some embodiments, each pin conductor 104 has a proximal end configured to face another connector that connects to the multi-port connector (e.g., a connector of the female-type connector 20 of FIG. 1A), and a distal end configured to face away from that other connector. The multi-port connector 100 includes a mount 105 at the distal end of each pin conductor 104. The mount 105 can include a plurality of attachment pins 1051. In some configurations, four attachment pins 1051 can be arrayed around the mount 105.

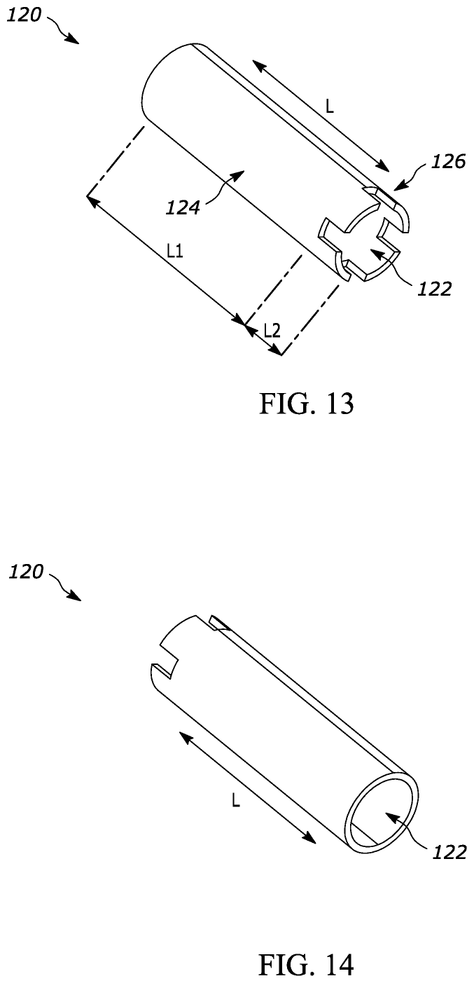

In some embodiments, as shown in greater detail in FIGS. 13 and 14, the multi-port connector 100 includes a plurality of cable seatings 120 having a through opening 122 along the longitudinal direction L thereof, in order to receive a conductive portion 152 (e.g., copper) of a coaxial cable 150. Each cable seating 120 is configured to be inserted within the mount 105 (e.g., between the plurality of attachment pins 1051) of a corresponding pin conductor 104 by an insertion depth D. In certain embodiments, the cable seatings 120 can be formed integrally with the mounts 105.

The cable seating 120 has a proximal first end portion 124 and that has a length L1 longer than the insertion depth D of the mount 105 (e.g., longer than a length L3 of the attachment pins 1051) in the longitudinal direction D. The cable seating 120 further has a distal second end portion 126 that can be fixed to a conductive portion 152 of a cable 150, while the conductive portion 152 passing through the cable seating 120 contacts the corresponding pin conductor 104. The cable seatings 120 can be cylindrical.

In some embodiments, the distal second end portion 126 can have a non-continuous opening, for example a crenulated opening, with a set of square-peaks separated by slots. Other shapes and configurations can also be used. One advantage of such a non-continuous outline can be to increase surface area available for a joining process. Furthermore, the irregular outline of the distal second end portion 126 can be latched on or contacted by a projection (not shown) of an inner portion of the housing 102 to prevent removal of the cable seating 120 after installation.

In various exemplary embodiments, at least a portion of the coaxial cable 150 can be fixed to the cable seating 120 through a joining process (e.g., soldering, brazing, welding, adhesive, etc.). For example, an exposed conductive portion 152 of the cable 150 can be joined to the cable seating 120. In certain applications the joining process is achieved through soldering the conductive portion 152 of the cable 150 to the sleeve 120. As noted above, the distal second end portion 126 of the sleeve 120 can have a structural feature which helps enhance a joining connection to the cable 150. Accordingly, the cable 150 and the cable seating 120 can be joined at a location spaced from the mount 105 along the conductor length.

In some embodiments, the cable seating 120 can be metallic. In other embodiments, the cable seating 120 can be non-metallic except for its distal second end portion 126. For example, the proximal first end portion 124 of the cable seating 120 can be made of plastic, while its distal second end portion 126 can be made of metal or can include a metallic material. In some configurations, the metallic distal end portion 126 can include a metal coating or metallic material applied via an adhesive. The metal of the distal end portion 122 can be suitable for soldering applications. The distal end portion 126 can also be made of or include a non-metallic material suitable for soldering applications. In some alternative embodiments, the material of the cable seating 120 can be selected to be used with a different joining process such as an adhesive connection.

In some embodiments, the cable seating 120 can form a friction fit or a snap fit with a corresponding mount 105, e.g., with the attachment pins 1051. Additionally or alternatively, the cable seating 120 can be glued to a corresponding mount 105. The mount 105 is configured to maintain the cable seating 120 secured within the mount 105. In some applications, however, a soldering or other joining connection can be made to the mount 105. For example, the attachment pins 1051 can be soldered to the cable seating 120.

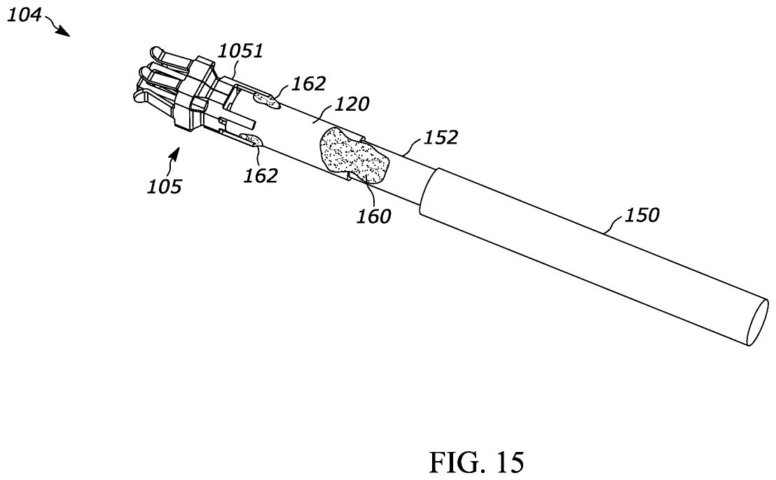

FIG. 15 shows an exemplary configuration of the cable seating 120 joined to the mount 105 and the cable 150. A first joining connection 160 attaches the conductive portion 152 of the cable 150 to the cable seating 120. One or more second joining connections 162 attached the cable seating 120 to the mount 105 at the attachment pins 1051. In an exemplary embodiment the joining connections 160, 162 are formed by soldering. The illustrated embodiment shows a soldering connection to a first attachment pin 1051 and an oppositely disposed second attachment pin 1051. In other configurations, all of the attachment pins 1051 can be soldered to the cable seating 120 or only one of the attachment pins 1051 can be soldered to the cable seating 120. This configuration can reduce the amount of solder needed to form a secure connection. As previously noted soldering to the mount 105 can be eliminated in some configurations.

During installation of a cable 150 a joining connection need not be made at the grounding plane GP which can reduce the required peripheral space for the connection, for example a soldering connection. In typical systems, extra space is needed to solder the cable, which requires a greater distance between adjacent cables and thus smaller diameter cables have to be used. In certain configurations, the thickness of the cable seating 120 can be much thinner than the space required for soldering in prior systems. Consequently, a much larger gauge, lower loss cable 150 can be used, compared to conventional systems. This in turns leads to various advantages over prior systems, such as much lower loss of signal, the ability to run much longer stretches of cable, the ability to use a smaller antenna due to the lower gain loss through the cable, and much more reliable signal levels. Examples of cables suitable for use with the multi-port connectors 100 can include, but are not limited to, ATS-100 (or other LMR-100 equivalents), ATS 195, LMR 195, or RGC-16 cables, whereas typical systems can only utilize RG 316 or equivalent cables. In some embodiments, the reduction of spacing needed to solder the cables can allow for spacing between the cables of less than 2 mm. For example between 2 mm and 0.5 mm or between 1.8 mm and 0.5 mm. In certain configurations spacing between the cables can be approximately 1 mm.

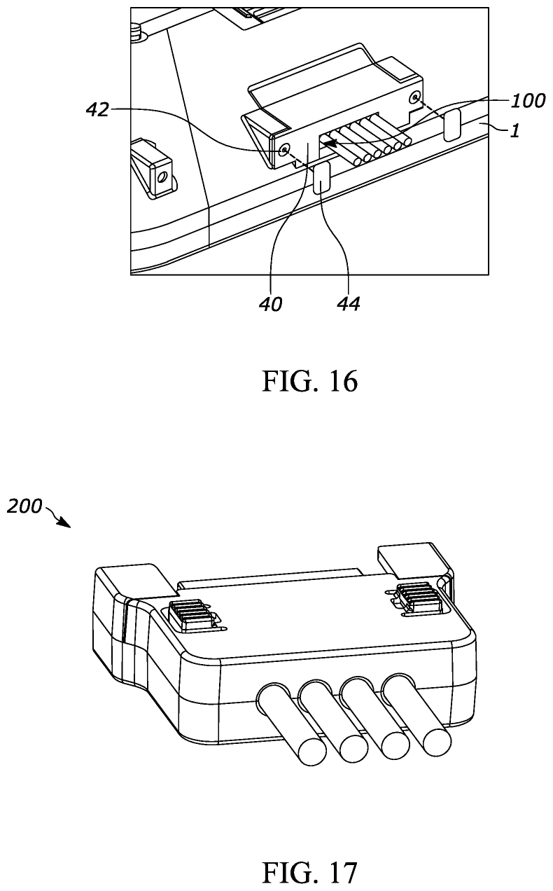

FIG. 16 shows that the multi-port connector 100 can be integrated with the conventional access point 1 of FIGS. 1A, 1B and 1C, by being connected with one of the female-type connectors 10, 20 of the access point 1 in a manner similar to that illustrated in FIGS. 1A, 1B and 1C, and by fixing a cover 40 using screws 42 and covering the screws 42 by stickers 44, thus providing a tamper-proof device with an integrated antenna.

While FIG. 3 shows a 6-port multi-port connector 100, FIG. 17 shows a 4-port connector 200. The configuration of this connector 200 is essentially identical to that of the connector 100 except for the number of ports. FIG. 17 is provided to illustrate that the exact dimensions and materials are not critical to the disclosure and all suitable variations should be deemed to be within the scope of the disclosure if deemed suitable for carrying out the objects of the disclosure. In this regard, the multi-port connector can be of any size, and can include any number of ports, as desired, without departing from the scope of the present disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein to particular multi-port connectors. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1. A multi-port connector comprising:
a housing having a male-type multi-port connection configured to fit within a female-type multi-port connection;
a plurality of pin conductors located at least partially within the housing and configured to electrically connect to the female-type multi-port connection;
a plurality of mounts positioned at least partially in the housing, each of the plurality of mounts connected to a respective pin conductor; and
a plurality of cable seatings positioned at least partially in the housing, each of the plurality of cable seatings connected to a respective mount;
a plurality of cables extending into the housing, each of the cables extending through a respective cable seating and connected to a respective pin conductor,
wherein each of the cables are respectively joined to one of the plurality of cable seatings.

2. The multi-port connector of claim 1, wherein the plurality of cables are low loss cables.

3. The multi-port connector of claim 1, wherein the cables are joined to the respective cable seating by soldering.

4. The multi-port connector of claim 1, wherein each of the plurality of cable seatings are inserted within the mount of a corresponding one of the plurality of pin conductors by an insertion depth and wherein a proximal first end portion of each of the plurality of cable seatings is longer than the insertion depth in the longitudinal direction.

5. The multi-port connector according to claim 1, wherein each cable seating is configured to form a friction fit with the mount of the corresponding one of the plurality of pin conductors.

6. The multi-port connector according to claim 1, wherein each cable seating is configured to form a snap fit with the mount of the corresponding one of the plurality of pin conductors.

7. The multi-port connector according to claim 1, wherein each cable seating includes a metallic portion and a non-metallic portion.

8. The multi-port connector according to claim 1, wherein a distal end portion of each cable seating has a square-wave outline at its distal end.

9. The multi-port connector according to claim 1, further comprising a latch extending in a proximal direction and configured to lock with a female-type multi-port connection when the male-type multi-port connection fits within a female-type multi-port connection, and
a button configured, when pressed, to displace the latch for unlocking from the female-type multi-port connection when the male-type multi-port connection fits within a female-type multi-port connection, wherein the button is positioned on the top portion of the housing.

10. The multi-port connector of claim 9, wherein the button is moveable in a first direction to displace the latch in a second direction.

11. A multi-port connector comprising:
a housing having a male-type multi-port connection configured to fit within a female-type multi-port connection, the housing having a first side and top portion extending from the first side;
a plurality of pin conductors located at least partially within the housing and configured to electrically connect to the female-type multi-port connection;
a latch extending in a proximal direction and configured to lock with the female-type multi-port connection when the male-type multi-port connection fits within the female-type multi-port connection; and
a button configured, when pressed, to displace the latch for unlocking from the female-type multi-port connection, wherein the button is positioned on the top portion of the housing.

12. The multi-port connector according to claim 11, wherein the button is moveable in a first direction to displace the latch in a second direction.

13. The multi-port connector according to claim 12, wherein the button is configured to displace the latch toward a central axis of the multi-port connector.

14. The multi-port connector according to claim 11, wherein the latch includes a base, a deflection member, and a prong.

15. The multi-port connector according to claim 14, wherein the button includes a leg having an angled engagement surface configured to engage the deflection member.

16. The multi-port connector according to claim 14, wherein the deflection member includes an arm configured to limit a pivoting movement of the prong.

17. The multi-port connection according to claim 11, wherein the button is connected to the top portion by a flexure.

18. A method of assembling a multi-port connection comprising:
extending a conductive portion of a low-loss cable through a cable seating;
joining the conductive portion to a distal portion of the cable seating;
positioning a proximal portion of the cable seating in a mount of a pin connector;
positioning the cable seating and the pin connector in a port of a housing, the housing having a plurality of ports for receiving respective cables.

19. The method of claim 18, wherein joining the conductive portion to the cable seating includes soldering the conductive portion to the cable seating.

20. The method of claim 18, wherein the cable is passed through an opening in the housing prior to joining the conductive portion to the cable seating.
